(19) United States
(12) Patent Application Publication
(10) Pub. No.: US 2002/0070258 A1
(43) Pub. Date: Jun. 13, 2002

(54) Tape dispenser with tape coding

(76) Inventors: George LeMoine, Trumbull, CT (US); John Nobile, Fairfield, CT (US)

Correspondence Address: Janik Marcovici, Perman & Green, LLP, 425 Post Road, Fairfield, CT, 06430, US

(21) Appl. No.: 09/935,892

(22) Filed: Aug. 23, 2001

Related U.S. Application Data
(60) Provisional application No. 60/228,529, filed on Aug. 28, 2000.

(51) Int. Cl. B65H 20/00; B41F 5/04

(52) U.S. Cl. 226/120; 101/219

(57) ABSTRACT

A tape dispensing apparatus comprising a frame, and a tape marking assembly. The frame has a tape supply section for holding a tape supply therein, and a tape dispensing opening for dispensing tape from the apparatus. The tape marking assembly is connected to the frame for marking the tape dispensed from the tape dispensing opening of the apparatus. The tape marking assembly is pivotably mounted to the frame for pivoting relative to the frame between an operating position, and a non-operating position of the tape marking assembly. The tape marking assembly includes at least one control arm extending between the tape marking assembly and the frame. The at least one control arm is spring loaded for biasing the tape marking assembly towards the operating position of the assembly. The at least one control arm bias on the tape marking assembly increases as the assembly is pivoted towards the operating position.

### CROSS-REFERENCE TO RELATED APPLICATION

This application claims the benefit of U.S. Provisional Application No. 60/228,529, filed Aug. 28, 2000, which is incorporated by reference herein in its entirety.

### BACKGROUND OF THE INVENTION

1. Field of the Invention

The present invention relates to a tape dispensing apparatus and, more particularly, to a tape dispensing apparatus with a tape coding or tape marking system.

2. Brief Description of Prior Developments

Packages and cartons which are being shipped from an initial location to some final destination are generally mailed with numerous codes and other indicia identifying various information to parties handling the packages and cartons between the initial location and their destination. The codes and other markings may be of numerous types. Some may be scanable by electronic or electro-optical means such for example bar codes. Others may be merely shorthand identifiers for items, or locations to be read by human or electronic operators such as for example the international three letter identifiers for airports (e.g. NWK for Newark International, or LAX for Los Angeles International airports). The conventional approach has generally employed self adhesive labels with the codes preprinted thereon, which are applied to the cartons or packages after the packages are sealed. Other approaches stamp the codes on the cartons or packages after they are sealed. Still other conventional approaches may use preprinted, self adhesive tape, such as conventional gummed tape having the codes preprinted thereon, for sealing the packages and cartons. This approach has an advantage over other conventional approaches described above in that the codes are applied to the packages at the same time that the packages are sealed. No further delays are incurred after the packages are sealed to apply the codes to the packages (at least with regard to those codes which are preprinted on the tape). This reduces shipping costs. Nevertheless, the use of preprinted tape with preprinted codes thereon has several significant limitations. For example, this approach lacks flexibility and does not include codes which vary between packages. The codes on the preprinted tapes are generally applied by the tape manufacturer well before the tape is used on packages by the shipper. Accordingly, the codes provided on preprinted tape are rudimentary, covering base information common to almost all packages shipped by the shipper. This excludes a large portion of codes addressing highly variable package specific information, which is not available on a cost efficient basis on preprinted tape.

### SUMMARY OF THE INVENTION

In accordance with a first embodiment of the present invention, a tape dispensing apparatus is provided. The tape dispensing apparatus comprises a frame, and a tape marking assembly. The frame has a tape supply section for holding a tape supply therein. The frame includes a tape dispensing opening for dispensing tape from the apparatus. The tape marking assembly is connected to the frame for marking the tape dispensed from the tape dispensing opening of the apparatus. The tape marking assembly is pivotably mounted to the frame for pivoting relative to the frame between an operating position and a non-operating position of the tape marking assembly. The tape marking assembly includes at least one control arm extending between the tape marking assembly and the frame. The at least one control arm is spring loaded for biasing the tape marking assembly towards the operating position of the assembly. The control arm bias on the tape marking assembly increases as the assembly is pivoted towards the operating position.

In accordance with a second embodiment of the present invention a tape dispensing apparatus is provided. The tape dispensing apparatus comprises a frame, a housing covering the frame, and a tape coder assembly. The frame has a tape supply section for holding a tape supply therein, and a tape dispensing opening for dispensing tape from the apparatus. The tape coder assembly is mounted to the frame for coding the tape dispensed from the tape dispensing opening. The tape coder assembly comprises a coding media supply element for holding a coding media supply. The tape coder assembly also comprises a code applicator for applying code media from the supply element to the tape. The tape coder assembly is movably mounted to the frame for moving relative to the frame between a first position and a second position. In the first position the tape coder assembly is located within the housing. In the second position, at least part of the tape coder assembly projects outside the housing so that the supply element and code applicator are accessible to a user.

In accordance with a third embodiment of the present invention, a tape coding device for forming a code on a tape is provided. The tape coding device comprises a support frame, a coding media supply element, and a code applicator. The coding media supply element is removably mounted to the support frame for holding a supply of coding media therein. The coding media supply element has first locking tabs for locking the supply element to the support frame. The first locking tabs are turnable relative to the support frame between a first position and a second position. The first lock tabs are turned to the first position to install and remove the supply element from the support frame. The first lock tabs are turned to the second position to lock the supply element to the support frame. The code applicator is removably mounted to the support frame for applying coding media from the supply element to the tape and forming the code on the tape when the tape is moved on the code applicator. The code applicator has second lock tabs for locking the code applicator to the support frame. The second lock tabs are turnable relative to the support frame between a first position and a second position on the second lock tabs. The second lock tabs are turned to the first position to install and remove the code applicator from the support frame, and are turned to the second position to lock the code applicator to the support frame.

In accordance with a fourth embodiment of the present invention a tape coding device for forming a code on a tape is provided. The tape coding device comprises a support frame, a coding media supply element, and a code applicator. The coding media supply element is removably mounted to the support frame for holding a supply of coding media therein. The code applicator is removably mounted to the support frame for applying coding media from the supply element to the tape and forming the code on the tape. The support frame has a first channel therein. The supply element has a slide member depending therefrom. The slide member is located in the channel when the supply element is mounted to the frame. The slide member is turnable in the channel relative to the support frame from a first orientation to a second orientation. In the first orientation the slide member is free to slide along the first channel. In the second orientation the slide member is clamped in the channel preventing the slide member from sliding along the channel.

### BRIEF DESCRIPTION OF THE DRAWINGS

The foregoing aspects and other features of the present invention are explained in the following description, taken in connection with the accompanying drawings, wherein:

FIG. 1 is a schematic perspective view of a tape dispensing apparatus incorporating features of the present invention, a section of tape dispensed from the apparatus, and a carton;

FIG. 1A is another schematic perspective view of the tape dispensing apparatus in FIG. 1 showing the housing of the apparatus in an open position;

FIG. 2 is a schematic partial elevation view of the tape dispensing apparatus in FIG. 1;

FIG. 2A is another schematic partial elevation view of the tape dispensing apparatus in FIG. 1 showing the tape coding mechanism in a down position in the apparatus;

FIG. 2B is still another schematic partial elevation view of the tape dispensing apparatus in FIG. 1 showing the tape coding mechanism in an up position;

FIG. 3 is an exploded perspective view of the tape coding mechanism of the tape dispensing apparatus in FIG. 1;

FIGS. 3A-3B are respectively an exploded front perspective view, and an exploded bottom perspective view of the tape coding mechanism in FIG. 3;

FIG. 4 is a side elevation view of a side support plate of the tape coding mechanism in FIG. 3;

FIGS. 5A-5B are respectively an exploded perspective view, and a cross-sectional view of a tape coding drum of the tape coding mechanism in FIG. 3;

FIGS. 6A-6B are respectively an top perspective view of a bottom perspective view of a coding ribbon of the tape coding drum of the tape coding mechanism; and

FIGS. 7A-7B are respectively a side elevational view, and a plan view of a turn/lock bushing of the tape coding mechanism in FIG. 3.

### DETAILED DESCRIPTION OF THE PREFERRED EMBODIMENT

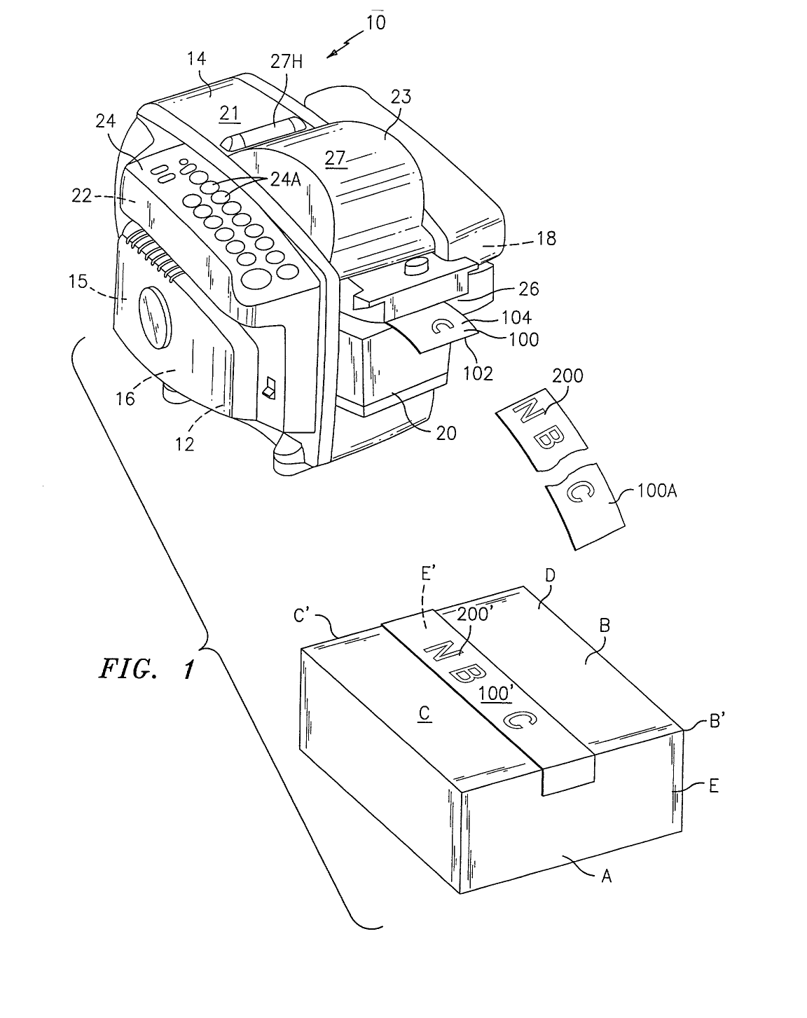

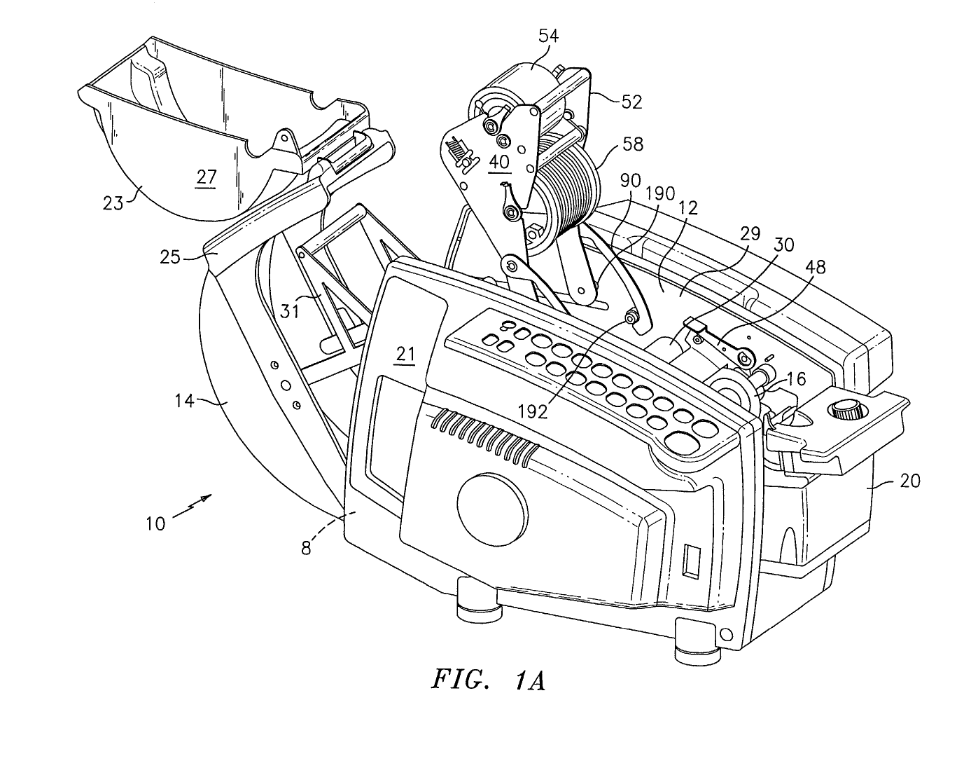

Referring to FIG. 1, there is shown a schematic perspective view of a tape dispensing apparatus 10 incorporating features of the present invention, a section of tape 100A dispensed from the apparatus 10, and a carton A sealed with tape from the apparatus. Although the present invention will be described with reference to the single embodiment shown in the drawings, it should be understood that the present invention can be embodied in many alternate forms of embodiments. In addition, any suitable size, shape or type of elements or materials could be used.

The package or carton A is shown for example purposes in FIG. 1, as having a general hexahedron shape. The carton A has at least two generally rectangular flaps B, C on at least one side D of the package. When the flaps B, C are folded closed, a seam E′ is formed between the flaps. Seams B′, C′ are also formed between the folded flaps B, C and one or more of the adjoining sides E of the carton A. In alternate embodiments, the package may be of any other suitable type or configuration, such as for example, seamed envelopes of suitable shape and size, or any other suitable containers or cartons of any other suitable shape, and having flaps forming sealable seams.

In accordance with the present invention, the tape dispensing apparatus 10 holds, and dispenses tape 100. The tape 100 is preferably gummed paper tape which has an adhesive underside 102. The adhesive on the gummed tape 100 is initially in an inactive state. When dispensed from apparatus 10, the tape 100 is cut by the tape dispensing apparatus 10 into sections, such as for example, sections 100A, 100′, of desired length to be used for sealing seams on packages. For example, the tape section 100′ is shown in FIG. 1 being used to seal seam E′ of carton A. The adhesive on the tape 100 is activated by the tape dispensing apparatus 10 so that cut sections, similar to sections 100A, 100′, are self-adhesive. When the section of tape 100′ is applied to carton A to close the seam E′ between flaps B, C, the section of the tape with activated adhesive attaches to the carton A thereby sealing the carton A. As will be described in greater detail below, tape dispensing apparatus 10 applies desired codes 200, 200′ to a non-adhesive surface of the tape 100 as the tape is dispensed by the apparatus. Tape sections 100A, 100′ dispensed from the apparatus have codes 200, 200′ affixed thereon. Application of the tape section, similar to section 100′, to the carton A results in simultaneous application of the codes, similar to codes 200′, to the carton A.

Tape 100 may be reinforced gummed paper tape, though any suitable type of tape may be used including plastic tape and non-reinforced paper tape. The tape 100 generally has a top layer (not shown) a pressure contact layer (not shown), reinforcing strands (not shown), and a bottom layer (not shown). The top layer and bottom layer are made of suitable paper. The contact pressure layer may be a suitable adhesive which holds the top layer, the reinforcing strands and the bottom layer together. The width of the tape is preferably about 60 mm, though the present invention is equally applicable to gummed tape of any width and length. The lower surface 102 (see FIG. 1) of the tape 100 has an adhesive (not shown) deposited thereon. The adhesive may be deposited on the bottom of the tape after the tape is manufactured, or during the manufacture of the tape. The adhesive is preferably a moisture activated adhesive, such as for example, an organic, non-toxic adhesive with a modified corn starch, smooth coat, high tack formulation, though any other suitable organic, or non-organic adhesive may be used. The adhesive may be deposited on the bottom surface 102 by any suitable means, such as spraying, rolling, or brushing the adhesive onto the bottom layer. The adhesive on the lower surface 102 of the tape 100 is in an inactive (i.e. non-adhesive) state when the tape is manufactured. The adhesive surface 102 may then be activated by adding moisture as will be described in greater detail below. The top surface 104 of the tape is not provided with an adhesive thereon.

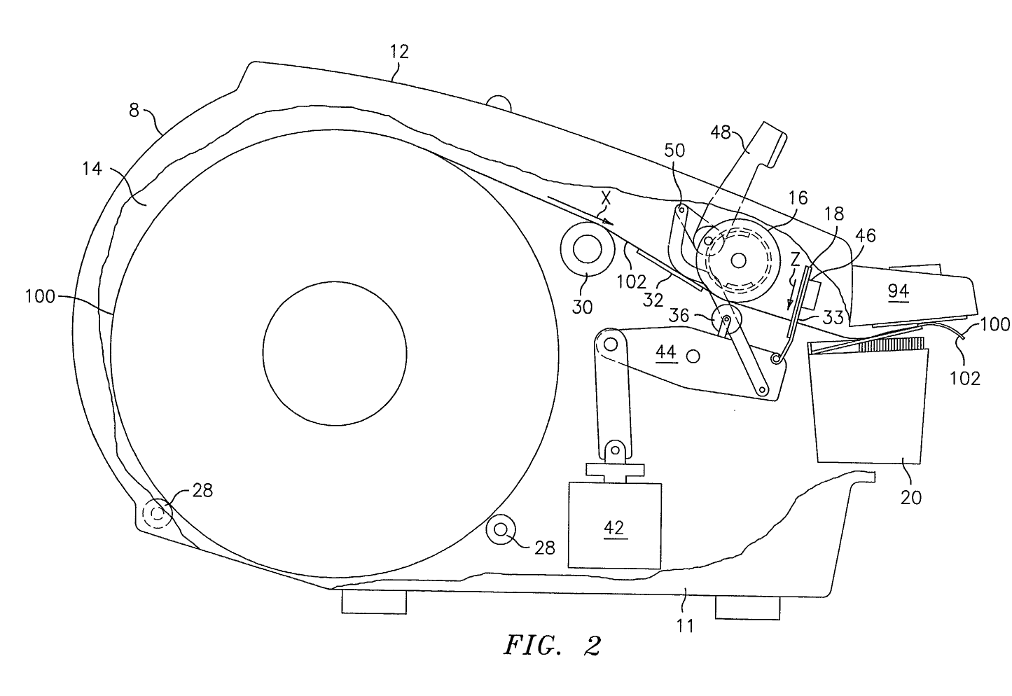

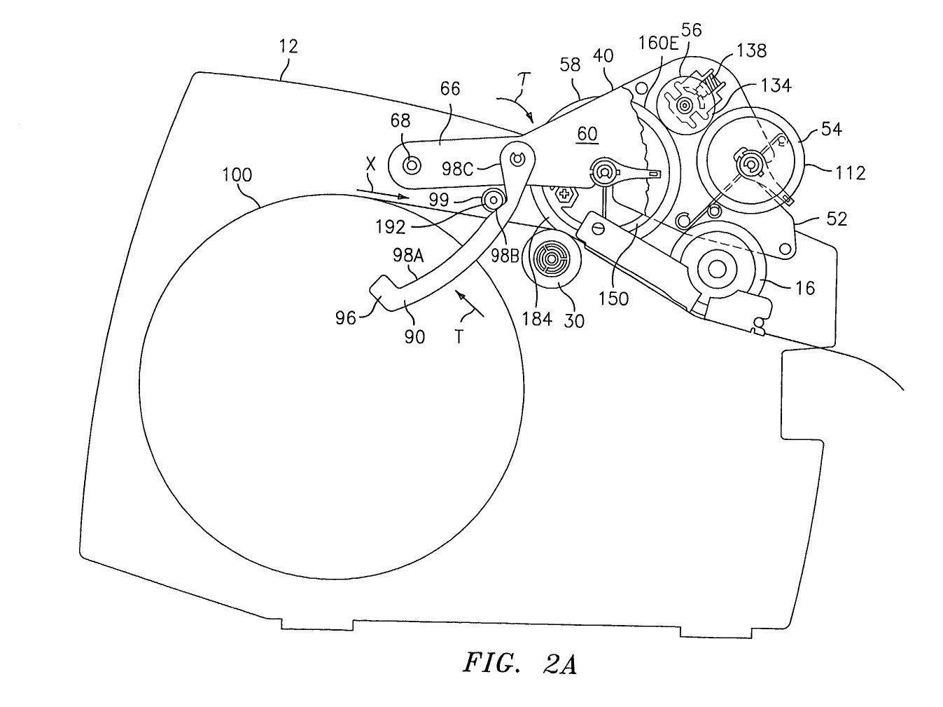

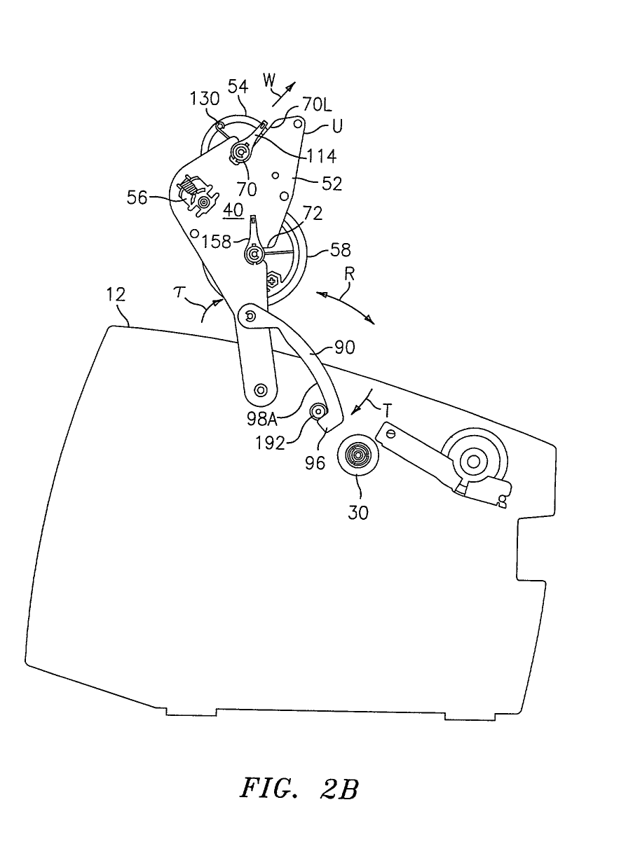

Referring now also to FIGS. 1A and 2, the tape dispensing apparatus 10 generally comprises a frame 12, a tape storage area 14 defined in the frame 12, a tape feeding mechanism 16, a cutting section 18, a tape wetting system 20, and a tape coding mechanism 40 (the coding mechanism is omitted from FIG. 2 for clarity). The feeding mechanism 16, cutting section 18, wetting system 20, and coding mechanism 40 are mounted to the frame 12. Housing 21 covers the frame 12. The tape dispensing apparatus 10 has an exit 26 through which tape 100 is dispensed. The tape is stored in the tape storage area 14. The feeding mechanism 16 draws tape out of the storage area and feeds it past the cutting section 18, wetting system 20, and coding mechanism 40, and then to the exit 26 through which the tape is dispensed from the apparatus. The coding mechanism 40 applies a code (similar to code 200) to the tape as will be described in greater detail below. The tape is cut at the cutting section 18. The wetting system 20 wets the tape to activate the moisture activated adhesive. Preferably, the apparatus 10 includes a programmable controller 22 which is controllably connected to the feeding mechanism 16, and cutting section 18 of the apparatus 10. A user interface 24 is provided to allow a user to interface with controller 22. In the preferred embodiment, the user interface 24 has function keys 24A, used by the user to input commands, such as for example, “Start/Stop”, and identifying the dispensed tape lengths, to the controller 22. In alternate embodiments, the user interface may use any other input means such as a touch display, or PC keyboard for entering commands in the controller.

As seen best in FIG. 1A, in the preferred embodiment, the housing 21 has a movable portion 25. Movable portion 25 is hinged at the rear to the frame 12 of the apparatus 10. The movable portion 25 of the housing may be rotated from a closed position, shown in FIG. 1 to an open position shown in FIG. 1A. In the open position, the movable portion 25 provides an access opening 29 into housing 21 and frame 12 of the apparatus 10. In an alternate embodiment, the housing may be provided with a removable section, in lieu of the movable portion for covering the access into the housing. As seen in FIGS. 1 and 1A; in the preferred embodiment, the upper portion 23 of the movable part 25 of the housing has a raised fairing 27 located towards the front of the apparatus.

The fairing 27 houses the tape coding mechanism 40, at least in part. In alternate embodiments, the housing of the apparatus may have any other suitable shape so that a fairing is not used for housing the tape coding mechanism. The fairing 27 is connected to the upper portion 23 by a hinge 27A (see FIGS. 1, 1A). The fairing 27 may thus be independently rotated, relative to the movable part 27 of the housing, between a raised position (shown in FIG. 1A) to a lowered position (shown in FIG. 1). FIG. 1A shows the movable part 25 in the opened position for example purposes, however the movable part 25 of the housing need not be opened for the fairing 27 to be rotated to its raised position. Accordingly, the fairing 27 may be rotated to its raised position (similar to the position shown in FIG. 1A) thereby providing access to the tape coding mechanism, even when the movable part 25 of the housing is down.

The tape storage area 14 is generally located towards the rear 8 of the frame 12 and housing 21, though in alternate embodiments the tape may be stored in any suitable location in the frame. In the preferred embodiment, the tape storage area 14 is sized and shaped to hold tape 100 in a roll configuration. The roll may be positioned vertically in the frame by support rails 31 (see also FIG. 1A). The support rails 31 may extend between the movable part 25 of the housing and the frame 12. The movable part 25 is rotated back to the opened position, which withdraws the support rails 31, at least in part, out of the frame 12 allowing installation and replacement of the tape roll in the support rails 31. In alternate embodiments, the tape may be stored in the storage area in any other suitable configuration. The tape storage area 14 is provided with support rollers 28 which, in cooperation with the support rails 31, support the tape roll stored in the storage area. The roller configuration shown in FIG. 2 is merely for example purposes, and the support rollers may be arranged in any other suitable configuration. The support rollers 28 are disposed to aid relatively unencumbered rotation of the tape roll when the feed mechanism 16 draws tape out of the storage area 14.

The feeding mechanism 16 generally comprises idler rollers (only one idler roller 30 is shown in FIG. 2 for example purposes), one or more guide trays 32, feed roller 34, pinch roller 36, and drive motor 15. The idler roller 30 is located between the tape storage area 14 and feed roller 36. The idler roller 30 supports and guides the tape in the feed direction (indicated by arrow X) to the feed roller 34. As shown in FIG. 2, one or more guide trays 32 are mounted to the frame 12 in the proximity of the feed roller 34. The guide trays are shaped and orientated such that the tape riding upon the guide trays 32 is orientated true to the feed direction X of the feed mechanism 16, and aligned with the feed roller 34. This prevents the tape from being skewed or twisted when fed by the feed roller 34. Feed roller 34 is preferably located towards the front 7 of the apparatus 10. The feed roller 34 is drivingly connected to electric motor 15 (see FIG. 1) by suitable transmission means (not shown) such as a belt, or chain drive. When the electric motor 15 is energized, under control from controller 22, the motor rotates the feed roller 34 in a suitable direction (e.g. counterclockwise) to transport the tape in the feed direction X of the feed mechanism. Friction contact between the feed roller 34 and the tape causes the tape to move when the feed roller turns. Friction contact between the tape and feed roller 34 is enhanced in the preferred embodiment by a pinch roller 36 which is located on the opposite side of the tape from the feed roller 34 (see FIG. 2). When in the engaged position, shown in FIG. 2, (the pinch roller also has a disengaged position as will be described below) the pinch roller 36 presses the tape against the feed roller 34 thereby increasing the friction force between roller and tape. From the feed roller 34, the tape is transported to the cutting section 18, wetting system 20, and exit 26 of the apparatus 10. In the preferred embodiment, the feed roller 34 is connected to a counter 35 which can indicate the rotation of the feed roller, and hence, the amount of tape being fed, to the controller 22. The feeding mechanism 16 described above and shown in FIGS. 1-2, is merely one example of a suitable feeding mechanism which may be used in the tape dispensing apparatus of the present invention. The present invention is equally applicable to dispensing apparatus having any other suitable feeding mechanism such as for example a manually operated feeding mechanism.

The cutting section 18 of the apparatus 10 has a cutting mechanism 38. The cutting mechanism 38, which is operated by controller 22 to cut the tape 100 fed past the cutting section 18, generally comprises one or more cutting blades 46, spring loaded solenoid 42, and pivot link 44. The cutting blade 46 is slidably supported in frame 12 by guide rails (not shown). Guide rails allow the cutting blade 46 to slide, in the direction indicated by arrow Z, between an up position (shown in FIG. 2), and a down position (not shown). In the preferred embodiment, the cutting blade 46 is orientated generally transverse to the tape 100 as the tape is being fed by the feed mechanism 16 past the cutting blade 46.

Cutting blade 46 is connected by a pin to one end of pivot link 44. Pivot link 44 is pivotably mounted in the middle to frame 12. The opposite end of pivot link 44 is connected to a spring loaded solenoid 42 which moves generally up and down when the solenoid is opened and closed. The up and down motion of the solenoid 42 is transferred to the cutting blade 46 by pivot link 44 so that the cutting blade is moved up and down under control of controller 22 (see FIG. 1). By way of example, in the preferred embodiment, cutting blade 46 is initially in the down position (not shown) and the solenoid 42 is open. When the solenoid 42 is energized, under a suitable command from controller 22, solenoid 42 is closed which pivots pivot arm 44 to move the cutting blade 46 to the up position shown in FIG. 2. De-energizing the solenoid 42 again causes the spring loaded solenoid 42 to return to its open position which, via pivot link 44, in turn moves the cutting blade 46 back to its down position. As shown in FIG. 2, pinch roller 36 of the feeding mechanism 16 may also be mounted off the pivot link 44 such that when the solenoid 42 is energized the pinch roller 36 is moved up to press the tape against the feed roller, and when the solenoid 42 is de-energized, the pinch roller 36 is moved down to release the tape (not shown). In alternate embodiments, the cutting blade may be moved up and down by any other suitable means such as directly driving the blade with a compressed air, or fluid piston.

In the preferred embodiment, the apparatus 10 may be provided further with a lift arm 48 (see FIGS. 1A, 2) for manually raising and lowering the cutting blade 46 in the frame 12. Lift arm 48 is pivotably connected to frame 12 so that the arm may be rotated between a lowered position and a raised position (arm 48 is shown in the raised position in FIG. 2 for example purposes). The arm 48 is connected via linkage 50 to the same end 46 of pivot link 44 to which the cutting blade 46 is connected. The cutting blade 46 may thus be raised and lowered manually by raising and lowering the lift arm 48.

Referring still to FIGS. 1-2, the wetting system 20 of the apparatus 12 generally comprises a fluid reservoir or bottle 20R, a basin or tray 20T, and a wetting brush 20B. Tray 20T is mounted to the front 7 of frame 12, and is open at the top. The tray 20T of wetting system 20 holds a suitable fluid, such as for example, water for activating the moisture activated adhesive on the tape dispensed from the apparatus. Bottle 20R holds a fluid reserve. The bottle 20R is mounted external to the housing 21 to feed reserve fluid into the tray 20T at a suitable rate to replenish the fluid therein. The reserve bottle 20R may be removable. This allows the bottle to be removed at a suitable time and refilled without interrupting operation of the tape dispensing apparatus. The wetting brush 20B is located inside the tray 20T, and sits in the fluid bath in tray 20T. As shown in FIG. 2, the top of the brush 20B projects above the lip of tray 20T. The brush 20B is made of a suitable material to allow fluid to be drawn, by capillary action, along the bristles of the brush from the fluid bath in which the brush is immersed to the top of the brush 20T. The tape 100 dispensed from the opening 26 of the apparatus 10 rests against the top of the brush 20T. As tape 100 is fed out of the apparatus, the tape moves over the top of the brush 20T which wets and activates the moisture activated adhesive on the lower surface of the tape 100 dispensed from the apparatus.

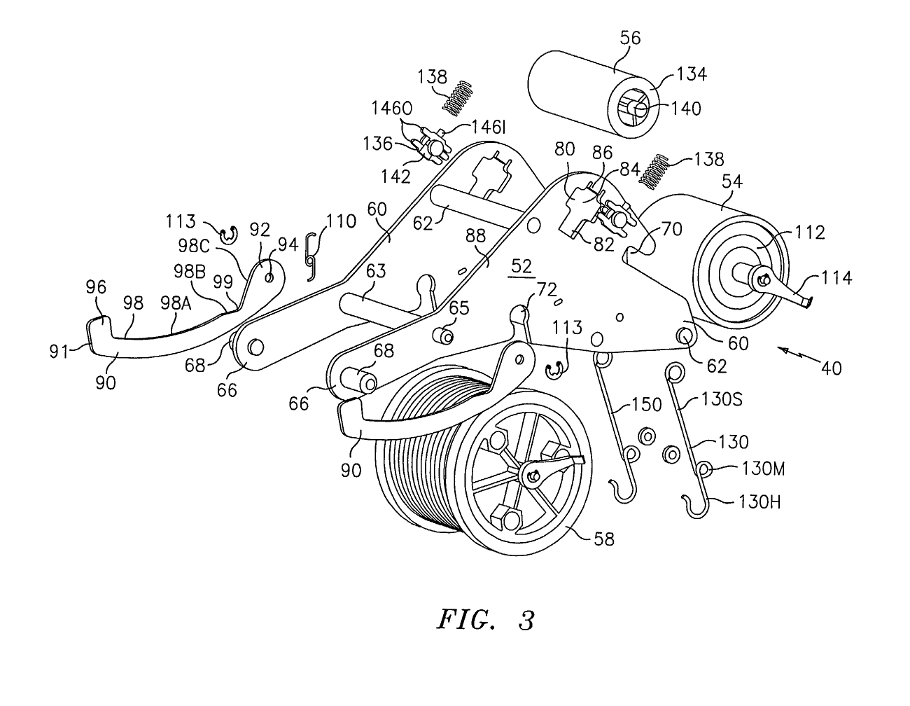

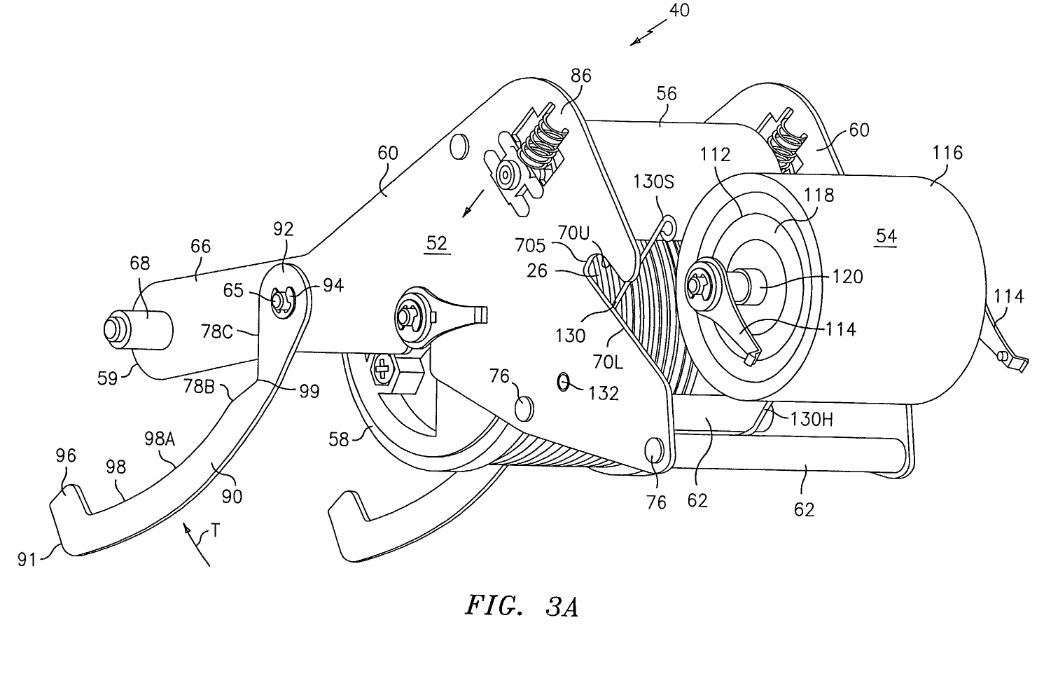

As noted previously, the code 200 may be applied to tape 100 in the dispensing apparatus 10 by the tape coding mechanism 40. Referring now to FIG. 3, there is shown an exploded perspective view of the tape coding mechanism 40 in the dispensing apparatus. Referring also to FIGS. 3A and 3B, there are shown respectively an exploded front perspective view, and a exploded bottom perspective view of the tape coding mechanism 40. The tape coding mechanism generally comprises a support frame 52, an ink supply roller assembly 54, an ink transfer roller assembly 56, and a tape coding drum assembly 58. The ink supply roller assembly 54, ink transfer assembly 56, and coding drum assembly 58 are rotatably mounted to the support frame 52. The ink supply roller assembly 54 includes a supply of ink. The ink supply transfer roller assembly 56 transfers a controlled amount of ink from the ink supply roller assembly 54 to the coding drum 58 thereby wetting coding features on the drum. The coding drum may then apply the code to the tape 100 moving past the coding mechanism 40. The ink supply roller assembly 54, and ink transfer roller 56 are spring loaded as will be described in greater detail below.

The support frame 52 of the tape coding mechanism 40 preferably comprises a pair of side plates 60, and connecting rods 62. As can be seen from FIGS. 3, 3A-3B, the side plates 60 of the support frame 52 are connected together by connecting rods 62 to form a substantially rigid box frame. In the preferred embodiment the support frame 52 includes three connecting rods 62. Each connecting rod 62 is preferably a one piece generally cylindrical member made of metal or plastic. In alternate embodiments, the frame of the coding mechanism may use any suitable number of connecting rods having any desired configuration. As seen best in FIG. 3 and 3B, the support frame 52 includes another connecting rod or shaft 63 located between side plates 60 towards the rear 59 of the frame. Shaft 63 is substantially similar to connecting rods 62 except that shaft 63 has spindles 65 extending from opposite ends of the shaft.

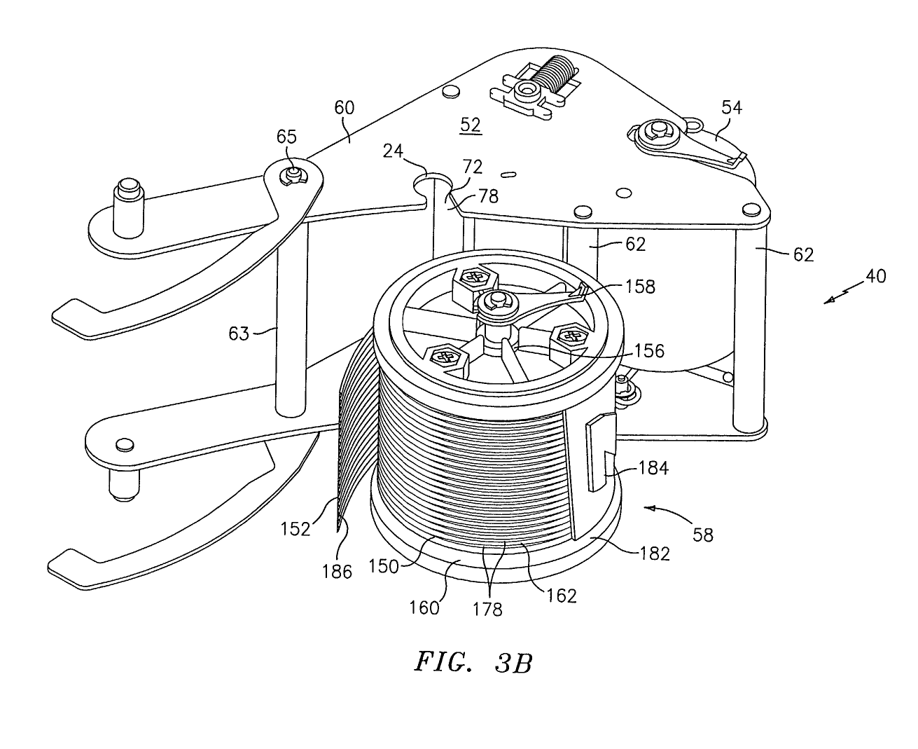

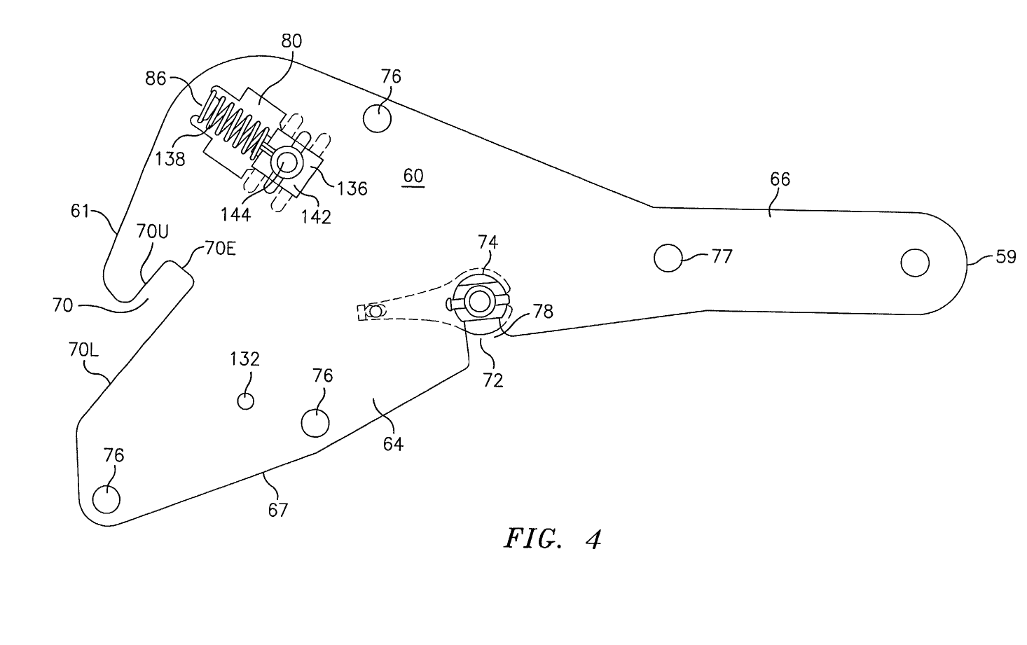

Referring now also to FIG. 4, each side plate 60 is also a one piece member cut or shaped from any suitable sheet metal, such as aluminum alloy or steel, or otherwise may be formed from plastic sheet. The side plate 60 preferably includes an enlarged main section 64 with a cantilever arm 66 projecting to the rear. As seen in FIG. 4 the main section 64 is provided with holes 76 for mounting the connecting rods 62 to the side plate. The cantilever arm 66 is also provided with a hole 77 for mating shaft 63 (see FIG. 3) to the side plate 60. The front edge 61 of the side plate 60 has a groove 70 formed therein. Groove 70 is used for mounting the ink supply roller assembly 54 to the support frame 52. As shown in FIG. 4, groove 70 has a substantially uniform width, though an alternate embodiments the groove may have any other suitable shape. The lower edge 70C of the groove 70 is substantially parallel to the upper edge 70U of the groove. The groove 70 is angled in plate 60 to facilitate replacement of the ink supply roller assembly 54 from the support frame 52 as will described further below. The lower edge 70L of the groove 70 is longer than the upper edge 70U. Along its lower edge 67, the main section 64 of the side plate has an open slot 72 for mounting the coding drum assembly 58 to the support frame 52 (see FIGS. 3B, and 4). Slot 72 has an enlarged end portion 74 communicating through a narrow neck section 78 with the opening of the slot. The end portion 74 has a generally rounded shape. The main section 64 of the side plate 60 also includes a slot 80 for mounting the ink transfer roller assembly 56 to the support frame 52. As seen in best in FIGS. 3 and 4, in the preferred embodiment, the slot 80 for the ink transfer roller assembly 56 is a closed slot having a generally rectangular configuration. In alternate embodiments, the slot for mounting the ink transfer roller may be an open slot, such as for example, a slot having a general “L” shape. Slot 80 has an enlarged upper section 84 which communicates with a narrow section 82. As seen best in FIG. 3A, the upper end of the slot 80 has a cantilever tab 86 which projects longitudinally into the slot 80. A spindle shaft is mounted on the exterior side 88 of the cantilever arm 66 of each side plate (see FIG. 3). A suitable bushing (not shown) such as an oil impregnated bronze bushing may be mounted on the spindle shaft 68. The support frame 52 is assembled by inserting connecting rods 62 and shaft 63 through the corresponding mounting holes 76,77 of the two side plates 60. The connecting rods 62 and shafts 63 are staked or brazed to the side plates 60 thereby securing the rods and shaft plates together. As seen in FIG. 3, when the support frame 52 is assembled, end spindle 65 of shaft 63 project outwards from the exterior of the frame 52. Spindle shaft 58 also cantilever outwards from the arms 66 on the side plate 60 of the support frame 52.

Still referring to FIGS. 3, 3A-3B, the end spindle 65 projecting from each side 60 of the support frame, provides support for mounting a pair of spring loaded control arms 90 to the support frames 52. The control arms 90 are substantially similar to each other. Each control arm 90 is preferably cut, stamped, or formed from any suitable sheet metal, or plastic sheet. Control arm 90 has a shoulder section 92 with a bore 94 formed therein. The bore 94 is sized to rotatably received a corresponding end spindle 65 of shaft 63 when the arm 90 is mounted on the shaft. At the opposite end 91 from the shoulder 92 the arm 90 has a stop tab 96 which projects laterally from the arm. A generally arcuate upper surface 98 extends between the shoulder 92 and stop tab 96. As seen best in FIG. 3, on the upper surface 98 generally defines three cam surfaces 98A-98C. The distal most cam surface 98A from shoulder 92 has a general curvilinear or radiused shape. Cam surface 98B is disposed at a downward angle relative to cam surface 98A as shown in FIG. 3A. Cam surface 98B may be radiused or flat. The angle of cam surface 98B is set to maximize the downward bias generated by the control arms 90 against the coding mechanism 40 when the mechanism is in its operating position as will be described in greater detail below. The proximal cam surface 98C is disposed at an upward angle relative to adjoining cam surface 98B as seen in FIG. 3. Cam surfaces 98B, 98C thus define a generally “V”-shaped recess 99 in the upper surface 98 of the control arm. As noted above, each control arm 90 is installed on the support frame 52 by mounting the arm onto a corresponding spindle 65 of shaft 63 (see FIGS. 3A-3B). Preferably, snap rings 112 are used to secure the control arms 90 to the shaft 63, though any other means for securing the control arms may be used. In the preferred embodiment, each arm 90 is spring loaded against the support frame by spring 110 (only one spring 110 is shown in FIG. 3 for example purposes). This spring 110, which is similar to a helically wound spring, may be mounted around shaft 63 extending between the control arm 90 and the cantilever arm 66 of the side plates 60 adjacent the control arm. The spring 110 biases the arm 90 in a clockwise direction (indicated by arrow T in FIG. 3A) towards the support frame 52. Referring now to FIGS. 3, 3A and 7A-7B the ink supply roller assembly 54 generally comprises a roller element 112 and a pair of turn/lock bushings 114. The roller element 112 preferably includes an inner core 118 and an outer sleeve or layer 116 which is supported by the inner core 118 to form the outer circumference 112. The inner core 118 may be made of plastic or metal as desired and may be shaped to provide a suitable support structure for outer sleeve 116. The inner core 118 may be provided with integral spindles 120 projecting from opposite ends of the rollers (see FIG. 3A). Otherwise, the inner core may have a bore formed therein for mounting a shaft through the core. The outer sleeve 116 preferably comprises an outer layer (not shown) made from foam plastic or any other open cell sponge material capable of absorbing, holding and releasing ink from the outer layer. The outer sleeve 116 slides on and off the inner core 118 during installation and replacement. FIGS. 7A and 7B respectively show an elevation view and a plan view of a turn/lock or quarter turned bushing 114. The turn/lock bushing 114 has a handle 124 with a roller bushing 122 mounted to the handle by any suitable fastening means. The bushing 122 may be made of plastic or metal (such as oil impregnated bronze) and a sized to be mounted on one of the spindles 120 projecting from the end of the roller element 112. The bushing 122 has outer cam lobes 128, with outer tabs 126 disposed therefrom. As seen in FIG. 7B, outer cam lobes 128 are located between tabs 126 and the handle 124. In the preferred embodiment, the cam lobes are generally aligned with the handle. Turn/lock bushings 114 are secured to the spindle 120 of the roller element 112 using snap rings similar to snap rings 113.

As can be seen in FIGS. 3, 3A the ink supply roller assembly 54 is mounted to support frame 52 with the turn/lock bushings 114 located in groove 70. To install the supply roller assembly 54 into the groove 70, the handles 124 and hence, the cam lobes 128 (see also FIGS. 7A-7B) on the turn/lock bushings 114 are aligned generally with the groove 70. In this orientation, the turn/lock bushings 114 may slide freely within the groove 70 thereby allowing the ink supply roller assembly 54 to be inserted into the frame 52. When the roller assembly 54 is inserted into the frame 52, the edges 70U, 70L of the groove 70 are received in the gap between tabs 126 and handles 124 of bushings 114, and conversely, the cam lobes 128 of the bushings are located in the groove 70. When the supply roller 74 is in the installed position and the support frame 52, the handles 124 are rotated approximately a quarter turn relatively to frame 52. Rotation of the handles 124, in turn engages the cam lobes 128 against the edges 70L, 70U of the groove 70 thereby locking the bushings 114, and hence, the entire roller assembly 54 in the support frame 52.

In the installed position, a pair of springs 130 preferably bias the ink supply roller assembly 52 out of groove 70 (in a direction indicated by arrow W in FIG. 2B). One spring 130 is mounted to each side plate 60 of the frame 52. The springs 130 are substantially identical to each other. Each spring 130 is preferably made of suitable spring wire. The spring wire is coiled to form a mounting section 130M (see FIG. 3). A hook shaped section 130H extends on one side of the mounting section 130M. A spring arm 130S extends from the other side of the mounting section. Each side plate 60 of the support frame 52 is provided with a spring mounting post 132 cantilever inwards from the side plate (see FIG. 3A). The spring 130 is mounted to the post 132 with the hook shaped section 130H hooked around an adjoining connecting rod 62 as shown in FIG. 3A. In this orientation the spring arm 130S of the spring 130 extends across the groove 70 of the side plate 60. When the ink supply roller assembly 54 is inserted into the support frame 52 as described above, the bushings 114 which are located in grooves 70 resiliently deflect the spring arms 130S toward the ends 70E of the groove.

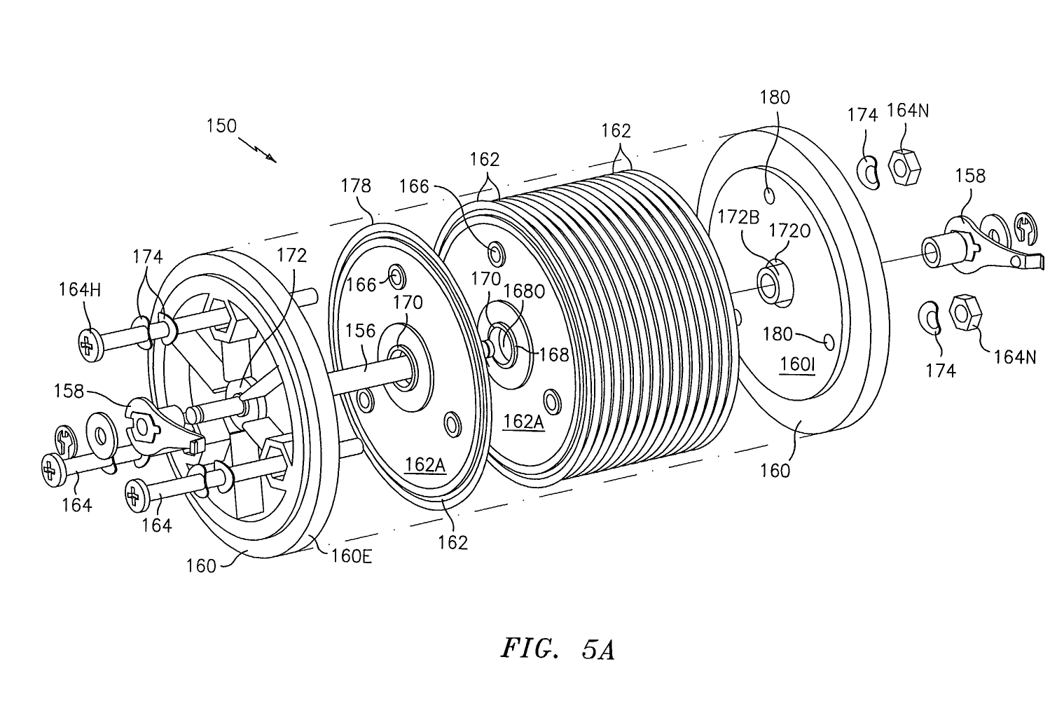

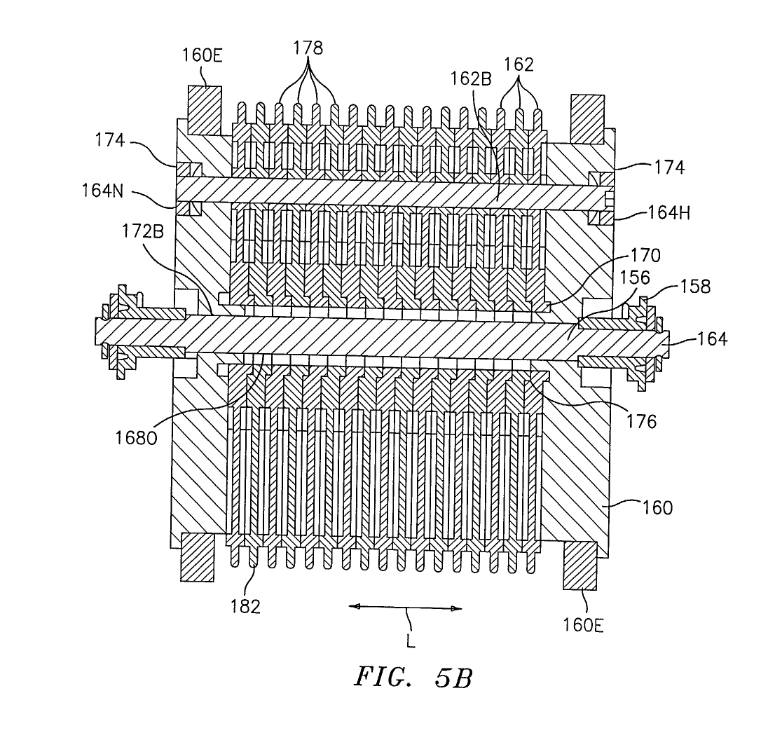

Still referring to FIGS. 3, 3A-3B, the ink transfer roller assembly 56 generally comprises a roller element 134 and spring loaded side bushings 136. The roller element 134 may comprise an inner core made of metal or plastic with an outer sleeve or layer made of neoprene rubber, or any other suitable material. The inner core may be mounted on a shaft (not shown) which has spindles 140 projecting from the sides of the roller. In alternate embodiments, the spindles may be integrally formed with the inner core. Slide bushings 136 are mounted on the spindles 140 of the roller element 134. Each slide bushings 136 is preferably made of plastic or suitable metal such as oil impregnated bronze. Referring to FIG. 4, the bushing 136 has a linear slide section or block 142 with a bore 144 sized to receive a spindle 140 therein. The linear slide block 142 is shaped to form a sliding fit with section 82 in slot 80. Inner and outer guide fingers 146I, 1460 project from opposite sides of the linear slide block 142. The inner and outer guide fingers 146I, 1460 are disposed to hold the edge of the slot 80 inbetween when the slide bushing 136 is in the slot. Inner fingers 146I are sized to allow the slide bushings 136 to be inserted into slot 80 through the enlarged section 84. Outer fingers 1460 are larger than the inner fingers and catch the edges of the enlarged hole 84. As seen best in FIGS. 3A, 4, each slide bushing 136 is spring loaded when installed in groove 80 by coil spring 138. The coil spring 138 is sized to be admitted into slot 80. Spring 138 is captured in one end by tab 86. The other end of the spring rests against section 142 of the bushing 140 thereby biasing the transfer roller assembly 56 linearly along the slot 80 in the direction indicated by arrow U (see FIG. 3A). In the installed position on the support frame 52, the surface of the transfer roller 34 contacts the surface of the ink supply roller element 112 (see FIG. 2A). Referring now to FIGS. 3, 3A-3B, 5A-5B, in the preferred embodiment, the coding drum assembly 58 generally comprises drum 150, ribbon 152, shaft 156, and turn/lock bushing 158. FIGS. 5A-5B respectively show an exploded perspective view, and a cross-sectional view of drum 150. The drum 150 generally includes disks or plates 162, cover or end plates 160, shaft 156, and fasteners 164. Each inner disk 162 is cut or formed from any suitable plastic or metal sheet. The disk 162 has a center boss 168 with a bore 1680 therein sized to form a clearance fit with a shaft 156. The boss 168 has a lip projecting laterally from the side 162A of the disk 162 as can be seen in FIGS. 5A, 5B. On the opposite 162B of the disk 162, the boss 168 has an annular recess 176 formed therein. The recess is sized to conform to the projecting lip 170 of an adjoining disk 170. Thus, when two disks 162 are stacked together with the side 162A of one disk 162 abutted to the side 162B of the other disk 162, the lip 170 of one disk is received into the mating recess 176 forming a close fit therebetween. The abutted disks are free to slide laterally relative to each other (as indicated by arrow L in FIG. 5B). Each disk may have holes 166 for inserting fasteners 164 therethrough (the disks in FIG. 5A are shown as having three through holes for example purposes). Each disk 162 has a peripheral ridge 178 extending around the outer circumference of the disk as shown in FIG. 5A, 5B. In alternate embodiments, the peripheral ridge may be segmented and distributed equally around the circumference of each disk. Several disks 162 may be stacked together to form the core of the drum 150. For example, in the preferred embodiment, seventeen disks 162 may be stacked together to form a drum used for coating a 60 mm tape. In alternate embodiments, the number of disks stacked together may be increased or decreased as desired to provide a coding drum with suitable for use with any tape of any width.

As can be seen in FIGS. 5A, 5B, the stack of disks is sandwiched or captured between end plates 160. Each end plate 160 is preferably a flat disk member made of any suitable metal or plastic. Each plate 160 has a hub 172 with a bore sized to form a running fit with shaft 156. As seen best in FIG. 5A, hub 172 has a boss 172B projecting from an inward side 160I of the end plate 160. The boss 172B is sized to be received in the center bore 168O of the disks 162. Around the boss 172B, the disk 168 has an annular groove 172G conforming to the projecting lip 170 of the inner disks 162 (see also FIG. 5B). Through holes 180 are formed into the end plates 160 for mounting fasteners 164. The end plates 160 have a substantially flat outer circumference edge.

Drum 150 is assembled by stacking the inner disks 162 together. The disks 162 are radially interlocked to each other by the mating lips 170 and recess 176 of adjoining disks. The end plates 160 may then be placed on either end of the disk stack. As seen in FIG. 5B, boss 172B of each end plate 160 is received into the bore 168O of the disks 162 proximate each end plate 160 to radially secure the assembly together. Through fasteners 164 (which may for example be machine screws or any other suitable type of through fastener) may then be inserted through the end plates and disks 160, 162, and secured with threaded nuts 164N. In alternate embodiments, the holes in one end plate may be threaded so that the fasteners may be secured directly to the end plate of the drum. The fasteners 164 are secured to provide some free play between the disks 162 in the direction indicated by arrow L in FIG. 5B. The interlocking lips and recesses 170, 176 between disks allow the disks to telescope in and out relative to each other. Belleville springs or wave washers 174 may be mounted on the fasteners 164 at one or both ends to control the lateral free play between the disks 162. FIGS. 5A and 5B show a representative placement of disks with two washers 174 placed in series at the head 164H of each screw 164, and one washer placed under the nut 164N. In alternate embodiments, any desired number of washers may be placed at any end of the through fasteners securing the drum. Shaft 156 is mounted through the hub 172 of the end plates 160. Turn/lock bushings 158 are mounted on the shaft 156 as shown in FIG. 5A, and secured with snap rings to the shaft 156. Turn/lock bushings 158 are substantially similar to the turn/lock bushings 114 described previously with reference to FIGS. 7A and 7B. As seen in FIG. 5B, when the drum 150 is assembled on the shaft 164, the circumferential ridges 178 of the disks are located radially below the circumferential edge 160E of the end plates 160. This provides a recess, or pocket 182 into which the ribbon 152 may be housed.

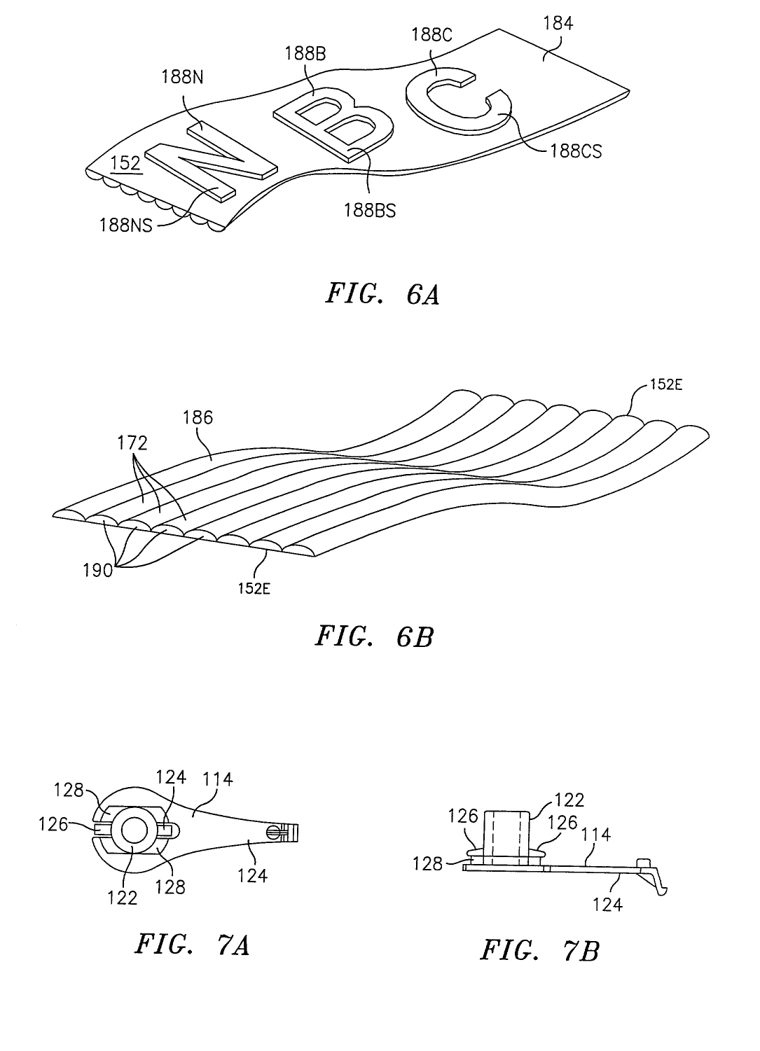

Referring now to also FIG. 6A, 6B, coding ribbon 152 may be made from rubber, Neoprene, or any suitable elastomer to provide the ribbon with sufficient flexibility and surface texture to facilitate no slip contact with the tape 100 (see FIG. 1) during operation of the tape coder. Ribbon 152 is sized to be mounted on the disks 162 of the drum 150 in the pocket 182 between the outer edges 160E of the end plates 160 (see FIG. 3B, and 5B). The ribbon 152 has one side 154 with raised features 188N, 188B, 188C disposed thereon. By way of example, the raised features 188N, 188B, 188C may define raised letters, such as N, B, C as shown in FIG. 6A. In alternate embodiments, the raised features on the coding ribbon may be any other desired symbols to be coded on tape dispensed from the apparatus such as numbers, comma, letters, bar codes, or pictographs. On the opposite side, the ribbon has a number of protruding ridges 190 which extend longitudinally along the ribbon. The ridges 190 define longitudinal grooves 192 inbetween, corresponding to the number of circumferential ridges 178 of disks 162 in the drum 150. By way of example, in the case of the ribbon used with a drum having seventeen disks (such as shown in FIG. 5A), the belt has seventeen ridges 192. The ribbon is mounted on drum 150 with the ridged side 186 against the ridges 178 of disks 162 and encoded side 184 on the outside as shown in FIG. 3B. The ribbon 152 is wrapped around drum 150, and the opposite ends 152E of the ribbon are connected together by any suitable removable splicing means (not shown). Ridges 178 of the inner disks of 162 of the drum 150 enter, at least in part, into corresponding grooves 192 of the ribbon 152. The engagement between the ridges 178 of the disks 162 and the grooves 192 of the ribbon keys the ribbon to drum 150. Hence, the ribbon 152 remains fixed in substantially one position along the drum 150. Mounting the ribbon 152 around the drum 150, places the flex ribbon 152 in hoop tension. The hoop tension on the flexible ribbon 152, draws the ribbon elastically around the drum 150, which in turn urges the ridges 178 of disks 162 into the corresponding grooves 192 of the ribbon. Conversely, the ridges 190 defining grooves 192 of the ribbon 152 are forced resiliently inbetween the ridges 178 of disks 162. As the ridges 190 on the ribbon 152, which has a wedge shaped cross-section (see FIG. 6B), are biased in between ridges of disks 162, the ridges 190 urge each of the disks 162 apart from the adjoining disks 162. The disks 162 are thus urged apart in the direction indicated by arrow L in FIG. 5B against the spring washers 174. Spring washer 174 are resiliently deflected thereby allowing the disks 162 to move apart sufficiently so that ridges 190 on the ribbon enter further between the mating ridges 178 of disks 162. In addition, the deflected springs 174 increase the pinch force of the disk ridges 178 on the ridges 190 of the ribbon 152 located therebetween. The increased pinch force of the disks 162 on the ribbon 152 effect an increase in the friction force between ribbon and disks thereby helping secure the ribbon 152 on the disk 150 and preventing the ribbon from slipping around the drum during operation of the tape coder. In alternate embodiments, the ribbon may be provided with keys to lock the ribbon to the drum. When the ribbon 152 is mounted on drum 150, the outer most surfaces 188NS, 188BS, 188CS of the raised features are substantially flush with or just below the outer edges 160E of the end plates 160. As can be realized from FIG. 3B, the coding drum assembly 58 is mounted between side plates 60 of the support frame 52 by inserting the turn/lock bushings 158 on the drum assembly 58 into slot 72. Turn/lock bushings 158 are inserted oriented (not shown) so that the bushings are aligned with the next section 78 of the respective slots, and are free to slide along the next section 78 into the enlarged holes 74 at the ends of the slots 72. When located in holes 74, the bushings may be rotated a quarter turn so that the bushings can no longer enter the next section 78 of the slots 72, thereby capturing the drum assembly 58 and the support frame 52. The bushings 158 allow the drum assembly to rotate relative to support frame 52. When the bushings 158 are located in holes 74 of slots 72, the drum assembly 58 is in its installed position within the support frame 52 (see also FIG. 2). In the installed position, the outer edges 160E of the end plates 160 on drum assembly 58 contact the roller element 134 of ink transfer roller 56 in the support frame 52. Springs 138 bias the ink transfer roller assembly 56 against the outer edges of 160E of the end plates 160 on the coding drum assembly. The outer most surface 188NS, 188BS, 188CS, of the raised features on the ribbon 152 of the drum 150 also contact the exterior of the roller element 134 of the ink transfer assembly 56. The contact pressure between the raised features of the ribbon 150 on the coding drum and roller element 134 of ink transfer assembly 156 is generally less than the pressure between the outer edges 160E of the end plates 160 of the coding drum 160 and the ink transfer roller element 134.

Referring now again to FIGS. 1A, and 2A-2B the coding mechanism 40 is preferably mounted to the frame 12 of the tape dispensing apparatus as an assembly with a coding drum assembly 58, ink transfer assembly 56, and ink supply roller assembly 54 mounted to support frame 52. In alternate embodiments, the support frame of the coding mechanism may be installed first, and then the coding drum assembly, ink transfer assembly, and ink supply roller assembly may be mounted separately to the support frame. The coding mechanism 40 is mounted to the apparatus frame 12 by placing the spindles 68 projecting outward from the ends of arms 66 on side plates 60 into pivot holes 190 (only one hole is shown in FIG. 1A) formed into frame 12. Arms 66 are sufficiently flexible so that the opposing arms 66 may be deflected towards each other to allow the spindle 68 to fit within the frame 12, and be placed within the pivot holes 190 in the frame. Spindles 68 are preferably provided with bushings (not shown) or otherwise may be made from a suitable bushing material such as plastic or bronze allowing the spindle to rotate in the pivot holes. This in turns allows the entire coding mechanism 40 to rotate relative to frame 12 of the apparatus in the direction indicated by arrow R in FIG. 2B. The coding mechanism is shown in an up position in FIG. 2B, and is shown in a down position D in FIG. 2A. As can be seen in FIG. 1A, the spring loaded control arms 90 of the coding mechanism 40 are disposed with cam surface 98 against cam rollers 192 (only one cam roller 192 is shown in FIGS. 1A and 2A) mounted to the frame 12 of the dispensing apparatus. The bias generated by the spring loading of the control arm in the directed indicated by arrow T, urges the arm against the cam roller and causes the arm to remain in contact with cam roller 192 when the coding mechanism 40 is rotated relative to the frame 12. As the coding mechanism is rotated relative to the frame 12, the cam surface of each of the control arms 90 rides on the cam roller 192. The camming action of the cam rollers 192 against the control arms 90 in turn generates a bias torque on the coating mechanism in the clockwise direction as indicated by arrow Z in FIGS. 2A and 2B. As seen best in FIG. 2B, stop tabs 96 at the end of the control arms 90 engaged the cam rollers 192 to hold the coding mechanism 40 from rotating beyond position U. Position U is located so that the center of mass of the coding mechanism 40 is sufficiently past the vertical so that the mechanism will not inadvertently rotate down to position D shown in FIG. 2A. In addition, the configuration of the cam surfaces 98 (described previously) of the control arms 90 is such that the biased torque T on the mechanism 40 generated by the cam rollers 192 increases from a minimum torque value when the mechanism is in an up position U (see FIG. 2B) to a maximum value when the mechanism is in the down D (See FIG. 2A). By way of example, as the mechanism is lowered from the up position U to the down position D, cam rollers 192 follow cam surface 198A of the control arms 90. As the cam rollers 192 follow the cam surface 98A, the cam rollers 192 cam the control arms 90 in a counterclockwise direction (opposite to the direction indicated by arrow T) away from the support frame 52. This increases the spring bias (in the direction indicated by arrow T) between the control arm 90 and the mechanism 40 with the corresponding increase in downwards bias torque generated on the mechanism 40. As shown in FIG. 2A, when the mechanism 40 is in the down position D, the spring loader control arms 90 are cammed to a position furthest from the support frame 52 thereby generating the greatest bias torque T on the mechanism. The cam rollers 192 are seated in notch 99 of the control arms 90 with cam surface 98B bearing substantially upwards against the cam rollers 192. The position of the cam rollers 192 over the cam surface 98B of control arms 90 tends to lock the mechanism 40 in the down position D further increasing the effectiveness of the bias torque T in urging the mechanism to position D.

As can be seen in FIG. 2A, when the coding mechanism 40 is in position D, the coding drum 150 of the coding drum assembly 58 rests against tape support roller 30. The tape 100 supported by tape roller 30 is thus pinched inbetween the coding drum 150 and the roller 30. The bias torque T on the mechanism presses the ribbon 152 on the coding drum against the tape 100 so that the tape 100 and the ribbon 152 make no slip contact. Accordingly, when the apparatus 10 is energized and tape 100 is fed by feed mechanism 16 in direction X (as described previously with reference to FIG. 2), the tape 100 causes the coding drum 150 to rotate. For example, when the tape 100 is fed in direction X, the tape 100 causes the coding drum 150 to rotate in a counterclockwise direction relative to support frame 52 of the mechanism. The rotation of the coding drum 150 as the tape 100 is moving under the drum sequentially presses raised features 188N, 188B, 188C on ribbon 152 against the upper surface of tape 100. As noted before, the outer edges 160E of the drum 150 form no slip contact with the ink transfer roller 134. Thus, the rotation of the coding drum 150 in turn causes the ink transfer roller element 138 to rotate. For example, counterclockwise rotation of coding drum 150 (due to tape 100 being fed in direction X) causes clockwise rotation of the ink transfer roller 134 relative to the support frame 52. In addition, contact between the ink transfer roller and the ink supply roller 112 causes the rotating ink transfer roller 134 in turn to counter rotate the ink supply roller 112. Clockwise rotation of the ink transfer roller 134, for instance, causes counterclockwise rotation of the ink supply roller 112 relative to the support frame 52.

As the ink supply roller 12 is rotated a controlled amount of ink from the surface of the roller 112 becomes entrained on the exterior of the ink transfer roller 134 thereby wetting the exterior of the ink transfer roller. The ink wetting the exterior of the ink transfer roller 134 is transferred in turn to the ribbon 152 on the coding drum 150 as the transfer roller 134 rotates over the coding drum 150. Ink from the ink transfer roller 134 wets the top surfaces 188NS, 188BS, 188CS of raised features 188N, 188B, 188C on ribbon 152 (see FIG. 6A) without wetting the adjoining surfaces of the ribbon 152. The top surfaces of the ribbon come in contact with the upper surface of the tape as noted before, and thus the top surfaces 188NS, 188CS, 188BS of the raised features are imprinted sequentially along the top of the tape thereby generating a code, such as for example, code 200 (see FIG. 1) on the tape 100 as the tape is being dispensed from the dispensing apparatus 10.

The coding drum assembly 58 and ink supply roller assembly 54 may be readily replaced by raising the coding mechanism 40 to the up position U shown in FIG. 2B. The turn/lock bushings 114 may then be rotated a quarter to release the turn/lock bushings 114 in groove 70 and unlock the ink supply roller assembly 54 from the support frame 52. Springs 130 biased against the spindles 120 (see FIG. 3A) of the roller assembly 54 urge the assembly in the direction indicated by arrow W out of groove 70. As shown in 2B, the groove 70 extend at an upward angle when the coding mechanism is in position U. This allows the user to easily lift the ink supply roller assembly 54 out of the support frame 52 and drop in a replacement supply roller assembly (not shown). The lower edges 70L of the groove 70 act as a guide when lowering in the supply roller assembly into the frame 52. Springs 130 stop the insertion of the supply roller assembly into the frame when the roller assembly (similar to assembly 54) is in the installed position. The ink supply roller assembly may then be readily secured to the frame by turning the turn/lock bushings similar to bushings 114 on the assembly to lock the bushings into grooves 70. The coding drum assembly 58 may be removed and replaced in a substantially similar manner as that described above for the ink supply roller assembly 54. Turn/lock bushings 158 are used to release the bushings in slot 72 and thus unlock the drum assembly 58 from support frame 52. Slot 72 are preferably oriented to a gentle upward pitch when the mechanism is in position U, allowing the drum assembly to be readily removed from the frame. A replacement drum assembly such as for example a drum assembly with a different coding feature disposed thereon, or a drum of a different width for use with tape of different width may then be installed in support frame 52 of the coding mechanism 40. The coding mechanism 40 may then be returned to position D shown in FIG. 2A, an operation of the tape dispensing apparatus 10 may be resumed in a manner similar to that previously described to apply codes similar to code 20 to the tape dispensed from the apparatus.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. A tape dispensing apparatus comprising:
a frame with a tape supply section for holding
a tape supply therein, and a tape dispensing opening for dispensing tape from the apparatus; and
a tape marking assembly connected to the frame for marking the tape dispensed from the tape dispensing opening of the apparatus, the tape marking assembly being pivotably mounted to the frame for pivoting relative to the frame between an operating position, and a non-operating position of the tape marking assembly;
wherein the tape marking assembly includes at least one control arm extending between the tape marking assembly and the frame, the at least one control arm being spring loaded for biasing the tape marking assembly towards the operating position of the assembly, the at least one control arm bias on the tape marking assembly increasing as the assembly is pivoted towards the operating position.

2. A tape dispensing apparatus in accordance with claim 1, wherein the tape marking assembly comprises a support section, the at least one control arm being pivotably mounted to the support section for pivoting relative to the support section when the tape marking assembly is pivoted between the operating position and the non-operating position.

3. A tape dispensing apparatus in accordance with claim 2, wherein the tape marking assembly comprises a spring extending between the at least one control arm and the support section, the spring being in a first position when the tape marking assembly is in the non-operating position, and being resiliently deflected by the at least one control arm from the first position to a second position when the tape marking assembly is moved from the non-operating position to the operating position.

4. A tape dispensing apparatus in accordance with claim 3, wherein the at least one control arm has a cam surface thereon which moves on a cam roller mounted to the frame when the tape marking assembly is moved between the non-operating and operating positions, the cam surface being shaped so that as the tape marking assembly is moved from the non-operating position to the operating position, the at least one control arm is cammed away from the support section by the cam roller increasing the resilient deflection in the spring.

5. A tape dispensing apparatus in accordance with claim 4, wherein the at least one control arm has a stop surface located at an end of the camming surface, the stop surface being engaged by the cam roller when the tape marking assembly is in the non-operating position, and wherein the control arm has a detent located at another end of the camming surface, the cam roller engaging the detent when the tape marking assembly is in the operating position.

6. A tape dispensing apparatus in accordance with claim 1, wherein the tape marking assembly has a pair of control arms.

7. A tape dispensing apparatus in accordance with claim 2, wherein the tape marking assembly comprises an ink supply roller for holding an ink supply therein, a tape marking drum assembly for applying markings to the tape, and a ink transfer roller for transferring ink from the ink supply roller to the tape marking roller.

8. A tape dispensing apparatus in accordance with claim 7, wherein when the tape marking assembly is in the operating position, the tape marking drum assembly is disposed in the frame to contact the tape in the apparatus.

9. A tape dispensing apparatus in accordance with claim 7, wherein the ink supply roller and the tape marking drum assembly are removably mounted to the support section, and wherein when the tape marking assembly is in the non-operating position, the ink supply roller and the tape marking drum assembly are disposed relative to the frame so that the ink supply roller and the tape marking roller are accessible for removal from the support section.

10. A tape dispensing apparatus in accordance with claim 7, wherein the tape marking drum assembly has an adjustable width, the width of the tape marking drum assembly being adjusted to correspond to a width of the tape dispensed from the apparatus.

11. A tape dispensing apparatus in accordance with claim 7, wherein the tape marking drum assembly comprises:
a support pin;
a pair of end plates removably mounted on the support pin; and
a predetermined number of disk elements removably mounted on the support pin, the disk elements being stacked side by side on the support pin to form a drum captured between the end plates;
wherein the predetermined number of disk elements mounted on the support pin depends on a width of the tape being dispensed from the apparatus.

12. A tape dispensing apparatus in accordance with claim 11, wherein the tape marking drum assembly further comprises a pair of springs mounted on the support pin, one spring from the pair of springs being mounted between each end plate and the stacked disk elements so that the pair of springs bias the stacked disk elements together.

13. A tape dispensing apparatus in accordance with claim 11, wherein the stacked disk elements define grooves around an outer circumference of the drum.

14. A tape dispensing apparatus in accordance with claim 13, the tape marking drum assembly further comprises a belt adapted to be disposed around the outer circumference of the drum, the belt having grooves formed therein which mate with the grooves in the outer circumference of the drum when the belt is disposed around the drum.

15. A tape dispensing apparatus in accordance with claim 11, wherein each disk element has a protruding lip conforming to a recess of an adjoining disk element when the disk elements are stacked together, the protruding lip and recess forming a rabbet fit between the adjoining disk elements when stacked together, and allowing adjoining disk element to telescope away from each other along the support pin.

16. A tape dispensing apparatus comprising:
a frame with a tape supply section for holding
a tape supply therein, and a tape dispensing opening for dispensing tape from the apparatus;
a housing covering the frame; and
a tape coder assembly mounted to the frame for coding the tape dispensed from the tape dispensing opening, the tape coder assembly comprising a coding media supply element for holding a coding media supply, and a code applicator for applying coding media from the supply element to the tape, the tape coder assembly being movably mounted to the frame for moving relative to the frame between a first position and a second position;
wherein in the first position the tape coder assembly is located within the housing, and in the second position at least part of the tape coder assembly projects outside the housing so that the supply element and code applicator are accessible to a user.

17. A tape dispensing apparatus in accordance with claim 16, wherein the tape coder assembly includes a support frame, the supply element and code applicator being removably mounted to the support frame.

18. A tape dispensing apparatus in accordance with claim 16, wherein the code applicator comprises:
a support pin;
a pair of end plates removably mounted on the support pin; and
a predetermined number of disk elements removably mounted on the support pin, the disk elements being stacked side by side on the support pin to form a drum captured between the end plates;
wherein the predetermined number of disk elements mounted on the support pin depends on a width of the tape being dispensed from the apparatus.

19. A tape dispensing apparatus in accordance with claim 16, wherein in the first position the tape coder assembly is disposed so that the code applicator contacts the tape in the apparatus.

20. A tape coding device for forming a code on a tape, comprising:
a support frame;
a coding media supply element removably mounted to the support frame for holding a supply of coding media therein, the coding media supply element having first lock tabs for locking the supply element to the support frame, wherein the first lock tabs are turnable relative to the support frame between a first position and a second position, the first lock tabs being turned to the first position to install and remove the supply element from the support frame, and being turned to the second position to lock the supply element to the support frame; and
a code applicator removably mounted to the support frame for applying coding media from the supply element to the tape and forming the code on the tape when the tape is moved on the code applicator, the code applicator having second lock tabs for locking the code applicator to the support frame, wherein the second lock tabs are turnable relative to the support frame between a first position and a second position of the second lock tabs, the second lock tabs being turned to the first position to install and remove the code applicator from the support frame, and being turned to the second position to lock the code applicator to the support frame.

21. A tape coding device in accordance with claim 20, wherein the support frame has grooves for mounting the supply element to the support frame, wherein each of the first lock tabs is connected to a corresponding slide member mounted to the supply element and disposed in a corresponding one of the grooves in the frame, and wherein when each first lock tab is turned from the first position to the second position, the corresponding slide member is turned from a first orientation to a second orientation relative to the groove.

22. A tape coding device in accordance with claim 21, wherein each slide member on the supply element is free to slide along the corresponding groove in the first orientation, and each slide member is prevented from sliding along the corresponding groove in the second orientation.

23. A tape coding device in accordance with claim 20, wherein the support frame has grooves for mounting the code applicator to the support frame, wherein each of the second lock tabs is connected to a corresponding slide member mounted to the code applicator and disposed in a corresponding one of the grooves in the frame, and wherein when each second lock tab is turned from the first position to the second position, the corresponding slide member is turned from a first orientation to a second orientation relative to the groove.

24. A tape coding device in accordance with claim 23, wherein each slide member on the code applicator is free to slide along the corresponding groove in the first orientation, and each slide member is prevented from sliding along the corresponding groove in the second orientation.

25. A tape coding device for forming a code on a tape, comprising:
a support frame;
a coding media supply element removably mounted to the support frame for holding a supply of coding media therein; and
a code applicator removably mounted to the support frame for applying coding media from the supply element to the tape and forming the code on the tape;
wherein the support frame has a first channel therein, and the supply element has a slide member depending therefrom, the slide member being located in the channel when the supply element is mounted to the frame, the slide member being turnable in the channel relative to the support frame from a first orientation to a second orientation, wherein in the first orientation the slide member is free to slide along the first channel, and in the second orientation the slide member is clamped in the channel preventing the slide member from sliding along the channel.

26. A tape coding device in accordance with claim 25, wherein the slide member is turned in the channel between the first orientation and the second orientation to lock and unlock the supply element to the support frame.

27. A tape coding device in accordance with claim 25, wherein the slide member of the supply element is rotatably mounted on a shaft depending from the supply element so that the supply element rotates freely relative to the slide member.

28. A tape coding device in accordance with claim 25, wherein the support frame comprises a spring, the spring being resiliently deflected by the supply element when the supply element is installed in the support frame, the resiliently deflected spring biasing the supply element in a direction along the first channel.

29. A tape coding device in accordance with claim 25, wherein the support frame has a second channel therein, and the code applicator has a slide member depending from the code applicator, the slide member of the code applicator being located in the second channel when the code applicator is mounted to the support frame, the code applicator slide member being turnable in the second channel relative to the frame from a first orientation to a second orientation of the code applicator slide member, wherein in the first orientation the code applicator slide member is free to slide along the second channel, and in the second orientation the code applicator slide member is clamped in the second channel preventing the code applicator slide member from sliding along the second channel and locking the code applicator to the support frame.

30. A tape coding device in accordance with claim 29, wherein the second channel has an enlarged pocket at one end, the code applicator slide member being disposed in the enlarged pocket when the code applicator is installed in the support frame, and wherein in the second orientation the slide member forms an interference with an adjoining portion of the second channel.

31. A tape coding device in accordance with claim 29, wherein the code applicator slide member is rotatably mounted on a shaft depending from the code applicator so that the code applicator is free to rotate relative to the slide member of the code applicator.

32. A tape coding device in accordance with claim 25, further comprising a coding media transfer element mounted to the support frame for transferring coding media from the coding media supply element to the code applicator.

33. A tape dispensing apparatus comprising the tape coding device in accordance with claim 32.
